(19) United States
(12) Patent Application Publication
(10) Pub. No.: US 2007/0146096 A1
(43) Pub. Date: Jun. 28, 2007

(54) Magnetron

(75) Inventors: Xiaodong Chen, Surrey (GB); Peter Lindsay, London (GB); Maurice Esterson, London (GB)

Correspondence Address: VENABLE LLP, P.O. BOX 34385, WASHINGTON, DC, 20043-9998, US

(73) Assignee: E2V TECHNOLOGIES (UK) LIMITED, Chelmsford (GB)

(21) Appl. No.: 10/568,974

(22) PCT Filed: Aug. 17, 2004
(86) PCT No.: PCT/GB04/03533

§ 371 Date: Aug. 29, 2006

(30) Foreign Application Priority Data
Aug. 18, 2003 (GB) 0319389.3

(51) Int. Cl. H01P 5/12

(52) U.S. Cl. 333/127

(57) ABSTRACT

A phase locked magnetron comprises a cathode and anode and an interaction space in between. The cathode is coupled to an injected locking signal, which prompts the operation of the magnetron to be in phase with the phase of the locking signal. From a magnetron of the type in which the cathode is at a large negative potential, the coupling to the locking signal is by non-contact means, in particular, by extending the cathode into a waveguide in which the locking signal is present. An alternative arrangement is for a magnetron of the type in which the cathode is substantially at ground potential. In this arrangement the coupling is by direct electrical connection to a conductor having the injected locking signal.

### FIELD OF THE INVENTION

This present invention relates to magnetrons, and in particular to a method and arrangement for phase locking a magnetron.

### BACKGROUND OF THE INVENTION

In one known magnetron design, a central cylindrical cathode is surrounded by an anode structure, which typically comprises a conductive cylinder supporting a plurality of anode vanes extending inwardly from its interior surface. During operation, a magnetic field is applied in a direction parallel to the longitudinal axis of the cylindrical structure and, in combination, with the electrical field between the cathode and anode, acts on electrons emitted by the cathode, resulting in resonances occurring and the generation of r.f. energy. A magnetron is capable of supporting several modes of oscillation depending on coupling between the cavities defined by the anode vanes, giving variations in the output frequency and power. The mode of operation, which is usually required, is the so-called Pi mode of operation.

The operation of a magnetron begins with a low voltage being applied to the cathode filament, which causes it to heat up. The temperature rise causes increased molecular activity within the cathode, to the extent that it emits electrons.

Electrons, being negative charges, are strongly repelled by other negative charges, and are repelled away from a negatively charged cathode and attracted to the anode. The distance and velocity of electron travel would increase with the intensity of the applied field between cathode and anode. The electrons thus accelerate towards the positive anode. As the electrons move from cathode to anode, they encounter the powerful magnetic field. The effect of the magnetic fields tends to deflect the electrons away from the anode. Instead of travelling straight to the anode, they curve relative to their previous direction, resulting in an expanding circular orbit around the cathode, which eventually reaches the anode.

The whirling cloud of electrons, influenced by the high voltage and the strong magnetic field, form a rotating pattern that resembles the spokes in a spinning wheel. The interaction of this rotating space-charge wheel with the configuration of the surface of the anode produces an alternating current flow in the resonant cavities of the anode. The electrons couple to the resonant cavities and give up energy to an RF field. As electrons are emitted from the cathode, some of these form a cloud of negative charge surrounding the cathode; so called space charge. The faster electrons experience a higher force from the axial magnetic field and tend to return to the cathode. Slower electrons experience a lower force and migrate to the anode. In a pulsed magnetron in which the high voltage between cathode and anode is pulsed, this prompts a pulsed path of electrons. The electrons spontaneously induce an RF field in the cavities of the anode, this being a semi-random process. Once existing, though, the RF field reinforces the electron motion, thereby maintaining the RF field with energy being gained by electrons from the high voltage field being given up to the RF field in the anode cavities.

As a magnetron may operate in a number of modes, there is a need to prompt the desired mode to be prominent; thereby ensuring energy is directed to that mode and not to other-modes. It is well known to design the anode so as to favour the desired mode by choice of anode shape, or by strapping. The cavity frequency depends on the cavity size because frequency is proportional to the inverse square root of LC, and L and C depend on the physical cavity size.

The operation frequency depends on the cavity dimensions. The phase, however, is randomly determined by the interaction of the electron cloud with the cavities when operation of the magnetron starts.

A magnetron is a compact and efficient source of microwave power. These advantages have resulted in numerous attempts in the past to develop methods of phase locking magnetron oscillators so that they can replace large and less efficient amplifiers in many applications. All these attempts have required high locking power, about 10 to 12 db below the output power of the magnetron by coupling a locking signal to the anode. Typically, therefore, applications requiring phase locking have used klystrons or lOTs instead of magnetrons.

We have appreciated the need for an efficient method of phase locking a magnetron.

The invention is defined in the claims to which reference is now directed.

In the invention, a locking signal is injected into the magnetron by a coupling, which couples the locking signal to the cathode. In a first embodiment, the coupling is by non-electrical contact and is achieved by an extended cathode, which protrudes into a region having a locking electromagnetic signal. The electromagnetic signal introduced in this manner couples to charge in the interaction space, thereby causing the circulating electrons to lock phase with the locking signal. This method of phase coupling requires a lower input power of locking signal to output signal ratio than previous techniques.

The coupling is arranged to be by non-electrical contact because the cathode is usually at a large negative voltage and an electrical contact to this large voltage would damage the generator of the locking signal and would be likely to short circuit the high voltage. It is thus important that the injected signal couples by a non-contact means, that is by electromagnetic coupling. The preferred choice is that the cathode itself extends into a waveguide in which the injected signal exists, but other types of coupling probe or loop coupled to the cathode on extending into the waveguide may be appropriate.

An altemative embodiment is to use a magnetron of the type in which the cathode is at ground potential and the anode is at a large positive potential. In this embodiment, the coupling may comprise a physical electrical connection.

A particular application of a phase locked magnetron is to high energy particle accelerators in which multiple accelerator cavities are connected in a chain, each driven by a respective RF source. By phase locking multiple magnetrons, these can be arranged to drive the cavities such that the phase of the accelerator cavities are defined and arranged so that the particle to be accelerated experiences acceleration as it passes from one accelerator cavity to the next.

### BRIEF DESCRIPTION OF THE FIGURES

Embodiments of the invention will now be described, by way of example only, and with reference to the figures, in which:

FIG. 1: shows the basic structure of a magnetron;

FIG. 2: shows various anode vane structures, including a so-called “rising sun” structure as may be used in embodiments of the invention;

FIG. 3: shows a magnetron according to a first embodiment of the invention;

FIG. 4: shows how the injected locking signal couples to the electron oscillation in the interaction region in the first embodiment;

FIG. 5: shows how a TEM wave travels along the coaxial line formed by the cathode and anode of FIG. 4;

FIG. 6: shows the voltage on a “arising sun” anode at a particular point in time;

FIG. 7: shows alternative coupling arrangements for a waveguide for the first embodiment;

FIG. 8: shows an alternative in which the coupling comprises a separate conductor coupled to the cathode for the first embodiment;

FIG. 9: shows a further alternative coupling for the first embodiment;

FIG. 10: shows a further alternative coupling for the first embodiment;

FIG. 11: shows multiple magnetrons coupled together;

FIG. 12: shows a directional coupler; and

FIG. 13: shows a magnetron according to a second embodiment.

### DESCRIPTION OF A PREFERRED EMBODIMENT

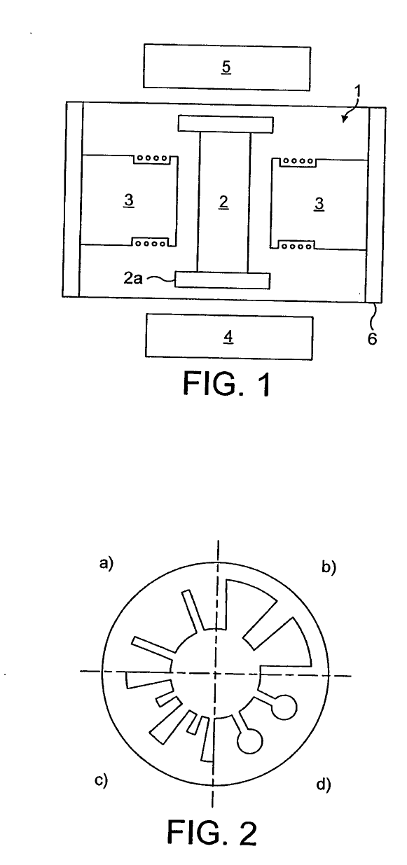

The basic structure of a magnetron is first described by way of background and is shown in FIG. 1. A cathode 2 is surrounded by an anode 6 having anode vanes 3 protruding into a cavity defined by the anode outer wall and creating an interaction space between the tips of the anode vanes and the cathode. The anode vanes 3 divide the interaction space into a plurality of cavities. Magnetic fields from a source pass through pole pieces 4,5 produce a magnetic field along the length of the interaction space parallel to the cathode 2. In use, electrons emitted from the negatively biased cathode 2 (with respect to the anode) are attracted by the anode 6 and are deflected by the magnetic field so as to circulate around the cathode 2. The electrons form a circulating cloud, which interacts with the cavities defined by the anode vanes inducing microwave oscillations. The microwave energy is typically extracted by a loop in one of the cavities to a waveguide. There are two types of magnetron biasing: inputting a large negative potential to the cathode and the anode being substantially at ground; or inputting a large positive potential to the anode and the cathode being substantially at ground. The invention can be used with either type and is reflected in the first and second embodiments.

The shape of the anode 6 can be one of a number of types, four of which are shown in FIG. 2. A slot type is shown in FIG. 2a, vane type as shown in FIG. 1 is shown in FIG. 2b, rising sun type in FIG. 2c and hole and slot type in FIG. 2d. The choice of anode type depends upon the frequency and power required as it affects the interaction of the circulating electron cloud with the anode, so as to favour the desired mode. The “rising sun” type is favoured in the embodiments of the invention for reasons explained later.

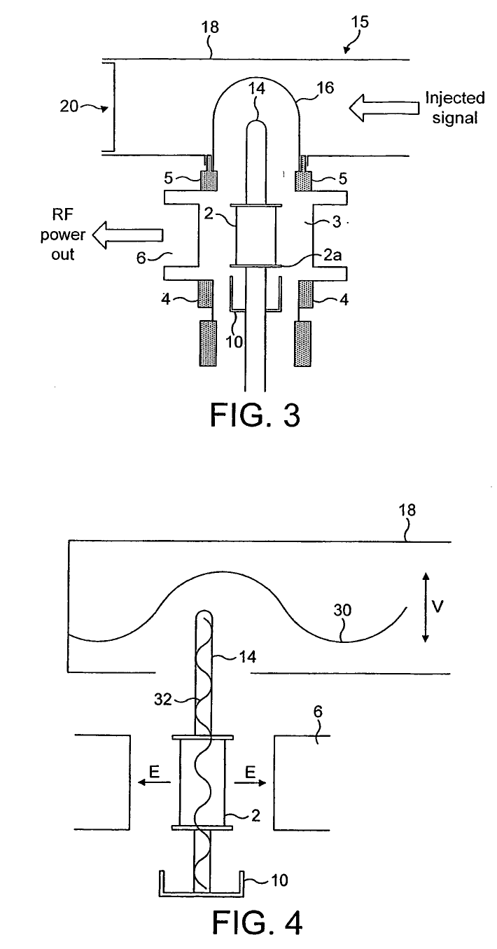

Previous methods have been based on injecting a locking signal into the magnetron anode cavities, either through the output connector or through an additional connection to the anode. With a high power magnetron the cathode lead will be at high voltage. We appreciated that it would be difficult to inject an RF signal into the anode/cathode volume through the cathode support because of the high voltage. In contrast, in the first embodiment of the invention, the technique used is to inject the locking signal directly into the charge in the interaction space by non-contact coupling to the cathode. In technical terms, a TEM wave is injected into the coaxial line formed by the anode and cathode. This approach can be used in magnetrons of the type in which the cathode is not a large negative potential. To do this, the cathode is extended into a dielectric window and inserted into a waveguide as shown schematically in FIG. 3.

Such an approach is counter intuitive and would have considered to be ineffective because, where a magnetron is oscillating in the desired Pi mode, there is no net radial electric field in the volume between the anode and cathode, so that there can be no coupling between the injected TEM mode and the Pi mode on the anode. However, it is known that the “rising sun” anode magnetron design, which has alternate large and small cavities, has a zero order mode in the anode/cathode volume when it is oscillating in the Pi mode. This mode has a uniform RF current circulating round the anode vane surfaces and a corresponding RF axial magnetic field at the Pi mode frequency. The inventors appreciated that, although this mode would not couple directly to a TEM mode in the anode cathode volume, coupling might occur when space charge was present near the cathode. This is because the space charge would be perturbed by the radial electric field of the TEM wave of the injection frequency when the electron velocities were low and there would be a perturbed circulating current producing an RF axial magnetic field that would couple to the zero order component of the Pi mode of the “rising sun” anode. If the injection frequency were close to the Pi mode frequency then, as the magnetron started to oscillate, it would lock to the injection signal.

Referring again to FIG. 3, the first embodiment comprises a cathode 2 at negative potential with cathode endhats 2a surrounded by an anode 6 with anode vanes 3 defining an interaction region between the cathode and anode. Pole pieces 4 and 5 define a magnetic field along the length of the cathode. A cathode support to a high tension supply 12 provides the high voltage needed on the cathode. The voltage supply may be pulsed for a pulsed magnetron or DEC for a continuous wave magnetron. So far, the embodiment is as described and uses like reference numerals as FIG. 1 for ease of reference.

The first embodiment additionally comprises a coupling 15 in the form of an extension of the cathode or an additional component added to the cathode shown as a probe 14, which extends from the cathode and into a waveguide 18 from which the interaction space is separated by a dielectric window 16. A moveable plunger 20 is provided and allows the waveguide to be configured so as to maximise the coupling of energy in the waveguide to the anode and cathode. The moveable plunger defines the position of the wave minima and hence the position of maxima (at the probe).

The locking operates as follows. A TE wave (typically a TE01 wave) injected into the waveguide 18 couples to the cathode and anode via the extension of the cathode 14 into the waveguide. As the cathode is concentrically surrounded by the anode, the cathode and anode effectively form a transmission line together along which a TEM wave can propagate. The TE01 wave thus couples to a TEM wave in the cathode-anode interaction region. The TEM wave has an electric vector which is radial between cathode and anode and which has frequency and phase defined by the injected signal in the waveguide. The phase of the magnetron is thus defined by the injected signal and once the magnetron is running the phase continues to remain locked to the injected signal.

The coupling of the TE wave in the waveguide 18 to a TEM wave in the interaction space is shown diagrammatically in FIG. 4. A TE wave 30 within the waveguide 18 has a varying electric field at the end of the probe 14 such that a time varying voltage is produced at the end of the probe. The probe conducts the varying voltage to the cathode as shown by wave 32. This varying voltage has an associated electric field transverse to the conductor and so when it couples to the cathode is effectively a TEM wave, as shown by the radial “E” field. There are two models describing how the TEM wave interacts with the magnetron operation.

In a first model, the transverse “E” field of the TEM wave, couples to charge cloud within the interaction space, prompting the charge to oscillate in accordance (and, therefore, in phase with) the injected signal. The electron motion from cathode to anode is thus prompted to adopt the phase of the injected signal. As the injected signal is chosen to be at the desired operating frequency (typically the frequency of the π mode), this prompts this mode to operate in favour of all others in addition to locking the phase to the injected signal.

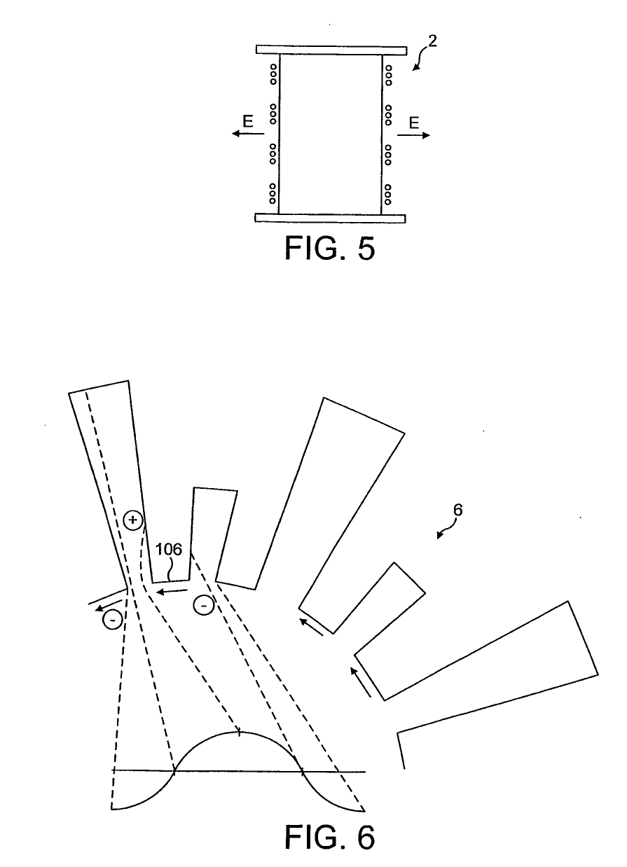

In a second model, the electron cloud near the cathode is moved by the TEM field in oscillations in a longitudinal direction of the cathode. This movement in itself generates a magnetic field, which induces currents in the vane tips of the anode, thereby causing the anode cavities to have a resonant frequency in phase with the injected signal. The electron movement is shown in FIG. 5.

The favoured choice of anode structure is the “rising sun” type for reasons explained by the second model above and as shown in FIG. 6. In a “rising sun” magnetron, alternate large and small cavities are used. In the π mode, a single cycle of the RF is spread across two adjacent cavities as schematically shown. In view of the differing cavity sizes, this means the anode tips 106 are not at nodes of the RF cycle as shown by the wave cycle mapped on to the anode with the result that there is a field direction and current at each of the anode tips as shown by the directional arrows. By coupling to this current at the anode tips, the current is locked to the injected signal.

Referring again to FIG. 4, the choke 10 can be chosen carefully so as to reflect the TEM RF signal so as to reinforce the injected TEM. This can increase the gain by either of the models described above.

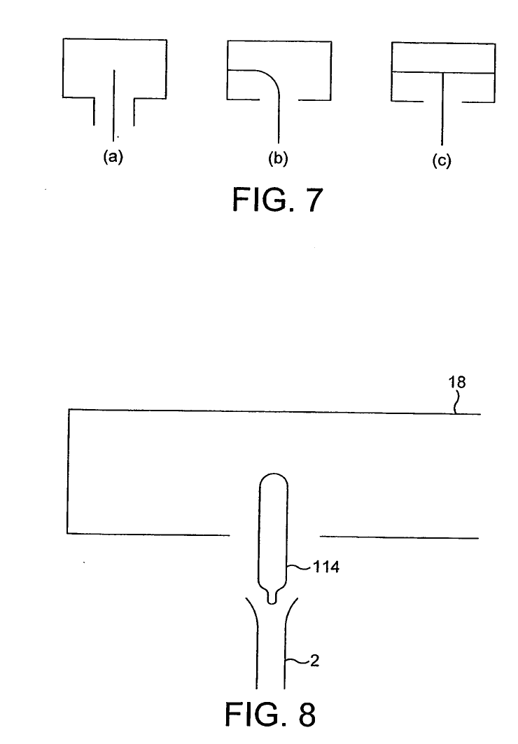

The preferred signal existing within the interaction space for phase locking is a TEM wave, but others may be suitable. As long as there is some distribution of space charge, this can couple to the transverse “E” field of the wave. TM waves may also work. Similarly, the injected signal could by any appropriate wave to which a probe or loop can couple. This is preferably a TE01 wave as this is simplest to couple to with a probe. Any mode that can exist and be coupled to would do, and alternative coupling arrangements are shown in FIGS. 7 to 11 for coupling in various ways and to differing waves. Waveguides are the preferred choice for the locking signal for efficient power transmission at RF frequencies.

The alternative coupling methods of FIGS. 7(a), (b) and (c) can be used for different wave types, in known fashion. The coupling arrangement of FIG. 8 uses a separate additional probe 114 rather than an extension of the cathode.

The injected signal is preferably at the end opposite the HT supply, but could be at other positions. The arrangement of the embodiment is convenient and also allows tuning using a moveable plunger (FIG. 3) to maximise the TE01 wave amplitude at the probe 14 as shown by wave 30 (FIG. 4).

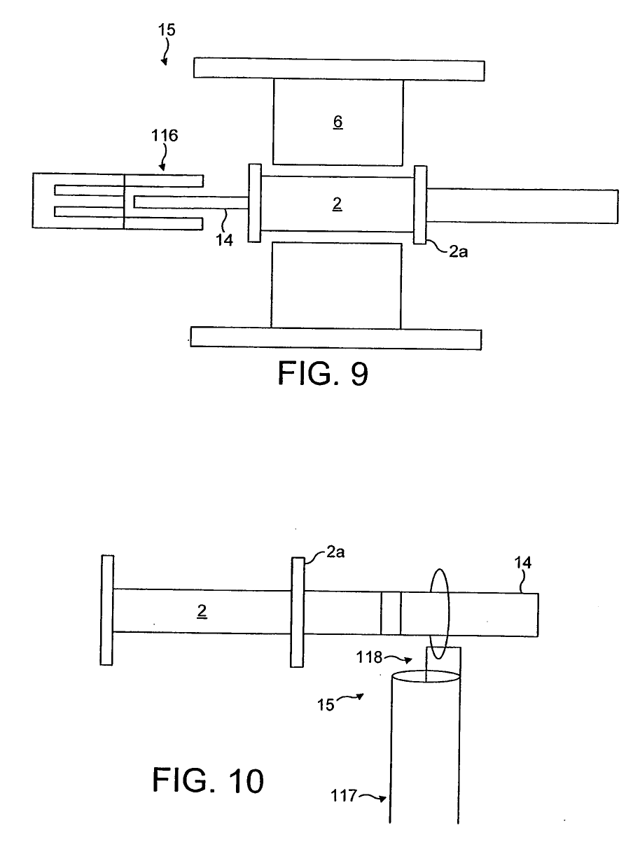

A further alternative coupling 15 according to the first embodiment uses a coaxial DC break 116 so that an RF signal can pass, but DC cannot. In this variation, the probe 14 couples by non-contact electromagnetic coupling to a TEM coaxial line, as shown in FIG. 9.

A yet further alternative coupling 15 according to the first embodiment uses a coaxial line 117 as the input for an RF locking signal and the coupling 15 comprises an inductive loop arrangement 118 which couples the wave in the input coaxial line 117 to the coaxial line formed by the cathode and anode.

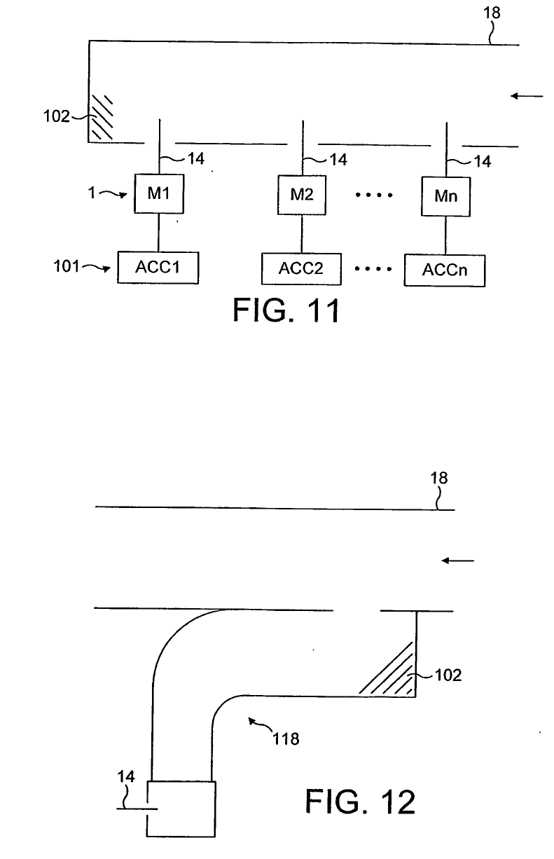

One main application of phase locking is to allow multiple magnetrons 1 to be locked in phase to drive separate phases 101 of a particle accelerator as shown in FIG. 11. In this arrangement, a single waveguide 18 is used to couple an injected signal to each respective probe 14. The magnetrons Mₗ, M₂ . . . Mₙ are thereby locked to the same phase. The injected signal may itself be produced by a continuous wave magnetron.

A further alternative coupling is shown in FIG. 12 and includes a load 102 to prevent any reflection from the probe 14 re-entering the waveguide 18.

The first embodiment so far described in its different variations has a cathode at negative potential and uses various coupling types to inject a locking signal into the cathode. The non-contact nature of the coupling overcomes the problem that the cathode has a large negative potential.

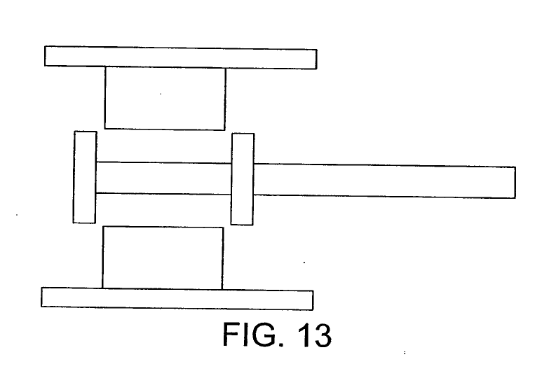

A second embodiment is shown in FIG. 13 and also has a coupling to the cathode for injection of a locking signal. However, in this embodiment, the cathode is at substantially ground potential. By using this type of magnetron the coupling can be a direct physical electrical connection as shown.

In both the first and second embodiments, the locking signal is injected direct to the interaction space by coupling to the cathode.

The typical operating conditions of a magnetron are calculated to be as follows:

| Anode Voltage | Anode Current | Pₒᵤₜ | Frequency |
|---|---|---|---|
| V_{DC} (kV) | (A) | (MW) | (GHz) |
| 170 | 8.18 | 695.3 | 1.13 |
| 180 | 11.86 | 1067.4 | 1.129 |

With no space charge and injection voltages of V_{DC}/10, V_{DC}/5, V_{DC}/3, only noise is generated in the anode cavities. When space charge is present and no injected signal, oscillation starts in about 10 ns.

When a signal of V_{DC}/10 at the Pi mode frequency is injected, oscillation started immediately the voltage was applied. The output signal was compared with the injected signal and it remained locked in phase for 550 ns, the duration of the applied pulse. If one assumes that the injected signal were completely absorbed at the cathode support end, the injected power would be (V_{DC}/10)²/2*ZO where Zo is the anode/cathode coaxial line impedance. This would be about 40Ω so that the input powers would be as follows:

| Anode Voltage | Pᵢₙⱼ | Ratio of | Gain |
|---|---|---|---|
| V_{DC} (kV) | (MW) | Pₒᵤₜ/Pᵢₙⱼ | (db) |
| 170 | 3.61 | 192.6 | 22.8 |
| 180 | 4.05 | 263.6 | 24.2 |

However, this is the most pessimistic assessment. With a choke of the cathode support end the injected signal would be reflected and the input power would be much lower. A directional coupler would be necessary in the injection signal waveguide to prevent the reflected signal returning to the signal generator.

1. A magnetron comprising a cathode and an anode, the anode surrounding the cathode and being arranged to define an interaction space between the cathode and the anode for containing space charge, the magnetron being operable at a desired frequency and having a coupling arranged to receive an injected signal for coupling the injected signal to the cathode the injected signal being at the desired frequency and having a signal phase, thereby causing the magnetron to operate according to the signal phase.

2. A magnetron according to claim 1, wherein the coupling is a non-contact coupling.

3. A magnetron according to claim 2, wherein the cathode is at negative potential with respect to ground.

4. A magnetron according to claim 1, wherein the coupling comprises a probe extending into a waveguide.

5. A magnetron according to claim 4, wherein the probe comprises an extended portion of the cathode.

6. A magnetron according to claim 4, wherein the probe comprises a separate conductor coupled with the cathode.

7. A magnetron according to claim 4, wherein the probe is arranged to couple to the injected signal formed as a wave in the waveguide thereby coupling the injected signal to the cathode.

8. A magnetron according to claim 1, wherein the injected signal is arranged to couple to the cathode and forms a TEM wave in the interaction space.

9. A magnetron according to claim 6, wherein the TEM wave couples to the space charge thereby causing the space charge to oscillate in accordance with the signal phase.

10. A magnetron according to claim 1, wherein the cathode being connected to a high voltage supply and having a choke to isolate the high voltage supply from the injected signal.

11. A phase locked magnetron arrangement comprising a plurality of magnetrons according to claim 1, wherein each of the plurality being coupled to the injected signal.

12. An arrangement according to claim 9, wherein each magnetron includes a probe extending into a common waveguide.

13. A particle accelerator comprising the arrangement of claim 9.

14. A synchrotron comprising the arrangement of claim 9.

15. A magnetron according to claim 1, wherein the coupling comprises an electrical connection and the cathode is substantially at ground potential.

16. A method of operating a magnetron, the magnetron having a cathode and a surrounding anode defining an interaction space, the method comprising injecting a locking RF signal into the cathode, whereby the magnetron is prompted to operate according to the phase of the locking signal.

17. A method according to claim 16, wherein the locking RF signal is injected as a TEM wave in the interaction space.

18. A method of operating a plurality of magnetrons comprising coupling the cathodes of the plurality of magnetrons to the same RF locking signal, whereby each of the plurality of magnetrons is prompted to operate according to the phase of the locking signal.
